(19) United States
(12) Patent Application Publication
(10) Pub. No.: US 2014/0259372 A1
(43) Pub. Date: Sep. 18, 2014

(54) Doorless Shower For an Aircraft

(71) Applicants: John W. Beard, Cibolo, TX (US); Michael G. Huber, Cibolo, TX (US); Debra Beard, San Antonio, TX (US)

(72) Inventors: John W. Beard, Cibolo, TX (US); Michael G. Huber, Cibolo, TX (US); Debra Beard, San Antonio, TX (US)

(21) Appl. No.: 13/837,977

(22) Filed: Mar. 15, 2013

(51) Int. Cl. B64D 11/00; A47K 3/28

(52) U.S. Cl. CPC B64D 11/00; A47K 3/284
USPC 4/614; 4/611; 29/428; 29/525.01

(57) ABSTRACT

A doorless, flexible shower stall for aircraft is shown, which shower stall is made of lightweight, 2-core-2 materials. The shower stall flexes as the aircraft flexes up to as much as five (5%) percent. The direction of discharge of water from the shower head is so the water will not be discharged out the doorless opening for the shower. Slopes of the floor is enough to overcome the angle of the aircraft during flight and still drain. The shower stall is composed of large pieces that are assembled and sealed when installed on the aircraft.

### FIELD OF THE INVENTION

The present invention relates a shower and, more particularly, a flexible, doorless shower for an aircraft.

### BRIEF DESCRIPTION OF THE PRIOR ART

With the growth of the aviation industry features have been added to aircrafts for the comfort of the passengers. While restrooms with toilets and laboratories were added to passenger aircraft years ago, in recent years showers have also been added to aircraft. However, showers create problems such as the following:
(1) because the fuselage of the aircraft flexes and twists during take-offs and landings as well as during flight, shower stalls must also flex and twist;
(2) if the shower stall does flex and twist any door for the shower will jam or stick;
(3) according to the Federal Aviation Administration, any door on a shower must be lockable so that it can be locked during take-off and landings; and
(4) a shower stall must be brought in and installed in large pieces and must be removable.

Showers have been designed for use in large aircraft in the past. For example, U.S. Pat. No. 6,602,709 assigned to the Boeing Company shows a shower with a foldable door and an expanding wall.

U.S. Pat. No. 6,407,512 assigned to Airbus Deutschland GmBH shows a shower for use in a passenger aircraft with rotating doors that may be closed when in use.

U.S. Publication No. US 2010/0101013 A1, published on Apr. 29, 2010 shows a modular shower cabin for aircraft that has a rotating door for closure.

Doorless showers for the home have been around for a long time as can be seen in U.S. Pat. No. 1,215,681 to Maury, et al.; U.S. Pat. No. 4,215,444 to Brown; and U.S. Pat. No. 3,060,453 to Shaw. However, the doorless showers in the home do not have to meet all the requirements that a shower in an aircraft would have meet, particularly, concerning flexibility.

### OBJECTS OF THE INVENTION

It is the object of the present invention to provide a doorless shower for an aircraft.

It is a further object of the present invention to provide a shower for an aircraft that will flex as the aircraft flexes during take-offs, landings and during flight.

It is yet a further object of the present invention to provide a lightweight structurally sound, yet flexible shower stall for installation on an aircraft.

It is yet another object of the present invention to provide a flexible, doorless shower stall for installation on an aircraft by using 2-core-2 material that is very lightweight yet strong.

It is still another object of the present invention to provide a shower stall that may be installed and removed from an aircraft as needed.

It is another object of the present to provide a lightweight, flexible, doorless shower stall for installation on an aircraft which shower stall is made in lightweight panels connected together upon installation in the aircraft. The shower stall is anchored to the ribs and cross beams of the aircrafts, and hence must flex as the aircraft flexes.

### BRIEF DESCRIPTION OF THE DRAWINGS

FIG. 1 is a partial cross-sectional view of a fuselage of a medium to large size passenger aircraft.

FIG. 2 is a perspective view of the shower stall shown in FIG. 1.

FIG. 3 is a top view of the shower stall shown in FIG. 2

FIG. 4 is a front elevational view of shower stall shown in FIG. 3.

FIG. 5 is a cross-sectional view of FIG. 4 along section lines 5-5.

FIG. 6 is a cross-sectional view of FIG. 5 along section lines 6-6.

FIG. 7 is a partial sectional view of FIG. 5 along section lines. 7-7.

FIG. 8 is a perspective view of the floor of the shower stall.

FIG. 9 is a perspective view of the shower stall with the twisting effect while in flight being shown in broken lines.

FIG. 10 is a front view of the shower stall with the twisting effect shown in broken lines.

FIG. 11 is an end view of the shower stall with the twisting effecting being shown in broken lines.

### DETAILED DESCRIPTION OF THE PREFERRED EMBODIMENT

Referring now to FIG. 1 of the drawings, an overhead partial sectional view of the fuselage 12 of a mid to large size passenger aircraft 14 is shown. Inside of the fuselage 12 maybe located rows of seats 16 or anything else to accommodate the passengers of the aircraft. Depending upon the desires of the owner of the aircraft 14, it may be a restroom 18 that has contained there is a toilet 20, the bidet 22, and a lavatory 24. The restroom 18 may be entered through door 26.

In the aircraft 14 as shown in FIG. 1, there is a second restroom 28 that may be entered through door 30. Immediately inside the restroom 28 is located a lavatory 32 where an individual may be able to wash their hands or face. A partial wall 34 separates the lavatory 32 from the toilet 36.

Restroom 28 is different from restroom 18 in that restroom 28 also has a shower stall 38 located therein.

Referring to FIG. 2, an enlarged perspective view of the shower stall 38 is shown. Along with more detailed views shown in FIGS. 3, 4, 5, 6, and 7, the shower stall 38 will be explained in more detail. The shower stall 38 has a top 40, bottom 42, and side walls 44 there between. The side walls 44 will be explained in more detail subsequently.

Within the shower stall 38 there is a stub wall 46 that extends inward a short distance in front of the doorless entrance opening 48. The stub wall 46 prevents water from the shower head 50 from being projected through the doorless entrance opening 48 when someone is taking a shower inside the shower stall 38. Within the shower stall 38 is located an amenities tower 52 that may include a soap holder 54 and hand grips 56. Also a foot rest 58 is provided on the side opposite the shower head 50. The bottom 42 slopes downward to the drain 60.

The shower stall 58 shown in FIGS. 2-7 is rectangular with the side walls 44 being made up of front wall 62, rear wall 64, left wall 66, and right wall 68.

Referring to FIG. 3, the top 40 is shown in more detail. The top 40 will include a pair of attachment brackets 70 secured thereto, which attachment brackets 70 will connect to ribs (not shown) of the aircraft 14. Top 40 may have a hole 72 cut therein so lights can be mounted with wiring for lights coming out through hole 72. Also, miscellaneous holes 74 may be cut in the top 40, which miscellaneous holes may have sensors connected therethrough or other features associated with the shower stall 38.

Referring to the cross-sectional view shown in FIG. 6, it can be seen that the top 40 may have a suspended ceiling 76 located therein. Above the suspended ceiling 76, wiring would be located for lights or any other features as provided in the shower stall 38.

Referring now to the side walls 44 that are made up by the front wall 62, rear wall 64, left 66 and right wall 68, the side walls 44 are made up of a sandwich panel typically having a Nomex honeycomb core with skins made up of plies of thermoset resin. These low density, lightweight cores between the skins dramatically increase the side wall stiffness with little added weight. The core functions like the connecting web of an I-beam, separating the face sheets at a uniform distance, while the skins themselves function as beam flanges. The panel bending stiffness is proportional to the core thickness.

The sandwich panels are cost effective because core material is less expensive and weighs less than the skin composite and can be cured and processed with the skins in a one shot operation. Usually, the core is faced with one or two skins of glass/phenolic prepreg for most ceilings and walls, and glass/epoxy or carbon/epoxy for panel floors, which require higher intentional strength. Because the side walls 44 normally have two layers of poly-setting resin over a honeycomb core, they are commonly referred to as “2-core-2.”

In making flat panels such as the side walls 44 (made up of front wall 62, rear wall 64, left wall 66, and right wall 68), the flat panels are typically processed with a flat press molding in which two lower skin prepregs, the honeycomb core and two upper skin prepegs are stacked onto a heated steel caul plate. A second, heated caul plate and a hydraulic press is lower onto the layout onto the laminate is held under pressure for a period of time ranging from 30 minutes to 100 minutes. A good discussion of this process is contained in Advanced Material for Aircraft Interiors: Composite World, November 2006, which is incorporated by reference.

The 2-core-2 compositions that make up the walls 44 of the shower stall 38 must be flexible enough to accommodate the flexing of the aircraft. The flexible nature may be up to five (5%) percent before the 2-core-2 material would start to fail. 2-core-2 sheets of flat composition panels can be ordered from Nordam.

The configuration of the shower stall 38 as is shown in FIG. 2-7, has the shower head 50 in a position so that as an individual takes a shower, the water will not be projected out through the doorless entrance opening 48 because of the stub wall 46.

According to FIGS. 7 and 8, the bottom 42 of the shower stall 38 is shown in more detail. The bottom 42 has attachment brackets 78 attached thereto. Attachment brackets 78 attached to the cross braces (not shown) contained within the aircraft 14.

The bottom 42 is formed on a mold which has a printed texture on top of the mold. The printed texture will be a resin film to give the texture to the bottom 42 where an individual stands in the shower. Under the textured pattern would be several additional layers formed from several plies of glass and/or liquid epoxy.

As can be seen in FIGS. 7-8, sloped surface 80 slopes downward to the drain 60. The slope of the slope surface 80 is always in excess of three (3°) degrees because the angle of attack of a passenger aircraft when in flight is approximately three (3°) degrees. Typically, the slope of the slope surface 80 would be approximately four (4°) degrees. Also, side sloped surfaces 82 (see FIG. 8) tend to direct the water towards the drain 60. Notch 84 in the bottom 42 coincides with the doorless entrance opening 48.

The top of the bottom 42 will be the inside of a mold and will have whatever decorative pattern therein the mold creates. The unfinished portion of the bottom 42 will be the lower surface thereof, which is hidden from the view of the passengers.

Referring to FIGS. 3, 4, and 5 in combination, the front wall 42, rear wall 62, left wall 64, right wall 66 are all connected together by corner brackets 86. The corner bracket 86 may have fasteners (not shown) glued within the honeycomb panel forming the sides 44, so that a bolt from the backside will attach the pieces together. The side walls 44 will be clamped together with screws from the unseen backside so that the shower stall 38 may be assembled or disassembled as desired. Silicone or some other flexible sealant will be used to ensure that there is no leakage at the corner brackets 86.

The bottom 42 and the top 40 will be connected to the side walls 44 by screws (not shown) connecting to fasteners (not shown) that are glued in the honeycomb panel. The screws will be inserted from the backside so they are not visible by the passengers.

Referring now to FIGS. 9, 10, and 11 in combination, the shower stall 38 is shown. The attachment brackets 70 for the top 40 are connected by connecting rods 88 to the ribs (not shown) of the aircraft 14. The bottom 42 is connected to cross braces (not shown) by attachment brackets 78.

As the aircraft 14 takes off, lands, and during flight, the shower stall 38 will flex as a result of the aircraft 14 flexing. The attachment brackets 70 and 78 will move, which will cause the shower stall 38 to flex as pictorially illustrated in FIGS. 9, 10, and 11 by the dotted lines. The amount of flexing in the shower stall 38 can be as much as five (5%) percent before it will begin to fail.

We claim:

1. A shower stall for installation on an aircraft with ribs and cross braces, such shower stall allowing passengers to shower with water during flight;
a lightweight top of said shower stall having upper attachment points for connecting to said ribs;
a lightweight bottom of said shower stall having lower attachment points for connected to said cross braces, said lightweight bottom being sloped toward a shower drain therein;
side walls of lightweight honeycombed material extending from said lightweight top to said lightweight bottom of said shower stall, said side walls having a doorless opening therein to allow access by a passenger into said shower stall;
a shower head positioned on, or adjacent, said lightweight top so that said water discharged from said shower head does not discharge out said doorless opening;
said shower stall flexing without damage thereto as said aircraft flexes during takeoff, flight and landings.

2. The shower stall for installation on an aircraft as recited in claim 1 wherein said shower stall includes on one of said side walls an amenities tower.

3. The shower stall for installation on an aircraft as recited in claim 2, wherein said slope of said lightweight bottom to said shower drain is at least four degrees.

4. The shower stall for installation on an aircraft as recited in claim 3, wherein said side walls are made from 2-core-2 material.

5. The shower stall for installation on an aircraft in claim 4, wherein said lightweight bottom is formed on a mold with decorative texture for the inside of said lightweight bottom being formed by said mold.

6. The shower stall for installation on an aircraft in claim 5, wherein said lightweight top has a false ceiling, lights for said shower stall being installed in said false ceiling.

7. The shower stall for installation on an aircraft in claim 6, wherein said side wall has a footrest formed therein.

8. The shower stall for installation on an aircraft in claim 5, wherein said shower stall is rectangular with said side walls include a front wall, a back wall, a left wall, and a right wall, said front, back, left and right walls being connected with corner brackets and sealed to prevent leakage.

9. The shower stall for installation on an aircraft in claim 8, wherein said front wall includes said doorless opening, a stub wall projecting inward from said front wall to prevent said water discharged from discharging out said doorless opening.

10. A method of installation of a shower stall on an aircraft having ribs and cross braces so that passengers in said aircraft may shower during flight with water in said shower stall, said method including the following steps;
first attaching a lightweight bottom from lower attachment points to said cross braces; said lightweight bottom being sloped downward to a drain therein;
second attaching a lightweight top from upper attachment points to said ribs;
installing sections of side walls together between said lightweight bottom and said lightweight top, said side walls having a doorless opening therein to allow access by a passenger into said shower stall, said side walls being made from lightweight reinforced material;
sealing said between (a) said lightweight top and said side wall, (b) said lightweight bottom and said side walls, and (c) said sections of said side walls, said sealing preventing said water from leaking from said shower stall;
locating a shower head in an upper area of said shower stall so that when said passenger is showering, said water is discharged therefrom onto said passenger without discharging through said doorless opening; and
flexing said shower stall during takeoff, flight or landing of said aircraft as said aircraft flexes.

11. The method of installation of a shower stall on an aircraft as recited in claim 10 wherein said flexing step may be up to five (5%) percent.

12. The method of installation of a shower stall on an aircraft as recited in claim 11 wherein said side walls are constructed from honeycombed 2-core-2 materials.

13. The method of installation of a shower stall on an aircraft as recited in claim 11 wherein said lightweight bottom is formed on a mold with decorative pattern therein to prevent by said passenger while showering.

14. The method of installation of a shower stall on an aircraft as recited in claim 13 wherein said slope of said lightweight bottom being in excess of four (4°) degrees.

15. The method of installation of a shower stall on an aircraft as recited in claim 14 wherein said side walls are generally flat to from a rectangular shaped shower stall, a stub wall extending inward adjacent said doorless opening to prevent said discharging of water through said doorless opening.

16. The method of installation of a shower stall on an aircraft as recited in claim 15 wherein said side walls are connected together by corner brackets and sealed.
